(19) United States
(12) Patent Application Publication
(10) Pub. No.: US 2013/0198353 A1
(43) Pub. Date: Aug. 1, 2013

(54) OVERLOAD HANDLING THROUGH DIAMETER PROTOCOL

(71) Applicants: Suzann Hua, Lisle, IL (US); Ahmed N. Zaki, Lisle, IL (US)

(72) Inventors: Suzann Hua, Lisle, IL (US); Ahmed N. Zaki, Lisle, IL (US)

(21) Appl. No.: 13/364,179

(22) Filed: Feb. 1, 2012

(51) Int. Cl. G06F 15/173

(52) U.S. Cl. 709/223

(57) ABSTRACT

Systems and methods that use Diameter protocol for notification of overload handling. A system includes a Diameter node that uses Diameter protocol. When in operation, the node receives a Diameter application request from a Diameter peer. In response to the application request, the node generates a Diameter application answer. The node also detects an overload condition, and inserts an overload indicator in the application answer that an overload condition exists. The application answer may include a new Attribute Value Pair (AVP) defined in the Diameter protocol for the overload indicator. With the overload indicator inserted in the application answer, the node transmits the application answer to the Diameter peer.

### FIELD OF THE INVENTION

The invention is related to the field of communication systems and, in particular, to network elements that communicate through Diameter protocol.

### BACKGROUND

The Diameter (base) protocol is an Authentication, Authorization, and Accounting (AAA) protocol used in communication networks. The Diameter protocol is a peer-to-peer architecture where a “Diameter node” implementing the Diameter protocol can function as either a client or a server depending on the network configuration. The term Diameter node herein refers to any functional element within a network communicating via the Diameter protocol, such as a process or a processing node that is operable with a network element.

Diameter nodes communicate with one another across a network by way of Diameter messages. A Diameter message is the unit of the Diameter protocol that one Diameter node uses to send a command or deliver a notification to other Diameter nodes. The data contained in the Diameter messages is transferred by a set of Attribute Value Pairs (AVPs). The AVPs carry the details of AAA as well as routing, security, and capability information between Diameter nodes. For instance, the AVPs are used by the Diameter protocol to support the transport of user authentication information for user authentication within a “Diameter server”. The AVPs also transport specific authorization information between “Diameter clients” and Diameter servers allowing peer Diameter nodes to decide whether a user's access request should be granted.

In IP Multimedia Subsystem (IMS) architecture, IMS elements exchange AAA information using the Diameter protocol. For instance, after collecting a user's credentials, such as username and password, an IMS element functioning as a Diameter client sends an access request to another IMS element serving the request. This Diameter server then authenticates the user based on the information provided by the Diameter client. If the authentication process succeeds, then the user's access privileges are included in an answer message to the Diameter client.

Before Diameter nodes can exchange information, the Diameter nodes establish a transport connection. Capabilities-Exchange messages defined in the Diameter protocol are used to establish the transport connection between Diameter nodes. The Diameter nodes exchange the Capabilities-Exchange messages to allow the discovery of the Diameter nodes' identities and capabilities, such as protocol version number, supported Diameter applications, security mechanisms, etc. The transport connection between the two Diameter nodes is then established so that the nodes can exchange application messages.

### SUMMARY

Embodiments described herein provide for handling overload conditions in Diameter nodes. A server in a packet-switched network may experience congestion, hardware or software failures, or some other issue that can overload the server. When the server experiences an overload condition, it cannot respond to requests in a timely manner as it can when operating under normal conditions. Diameter protocol as presently defined (such as by the Internet Engineering Task Force (IETF)) doesn't specify any type of overload handling between Diameter nodes. For example, if a Diameter node is experiencing an overload condition and another Diameter node continues to send requests as usual, then the overload condition will get worse and may eventually disable the transport connection.

The embodiments described herein add overload handling to the Diameter protocol so that overload conditions are managed in a Diameter node. If a Diameter node receives a request from a peer, then the node determines whether an overload condition exists. If so, the Diameter node is able to notify the Diameter peer of the overload condition through Diameter protocol. The Diameter peer then reduces additional requests toward the Diameter node that is overloaded. This reduces the burden on the Diameter node so that it can recover from the overload condition. When the Diameter node does recover, the node is able to notify the peer of the recovery so that the peer can send additional requests toward the Diameter node at a normal rate.

One embodiment comprises a Diameter node that uses Diameter protocol. The node is operable to receive a Diameter application request from a Diameter peer. In response to the application request, the node is operable to generate a Diameter application answer. The node is further operable to detect an overload condition, and to insert an overload indicator in the application answer that an overload condition exists. The application answer may include a new Attribute Value Pair (AVP) defined in the Diameter protocol for the overload indicator. With the overload indicator inserted in the application answer, the node is operable to transmit the application answer to the Diameter peer. The Diameter peer is advantageously notified of the overload condition in the Diameter node through the Diameter (application) answer.

In another embodiment, the Diameter peer is operable to receive the application answer, and to parse the application answer to identify the overload indicator which indicates that an overload condition exists in the Diameter node. In response to the overload indicator, the Diameter peer is operable to limit additional application requests toward the Diameter node based on the overload indicator. The overload indicator may indicate a severity level of the overload condition. For example, an integer value of 0 may indicate a normal operating condition and an integer value greater than 0 may indicate the severity level of the overload condition. Therefore, the Diameter peer may limit or throttle future requests toward the Diameter node based on the severity level.

In another embodiment, the Diameter node is operable to receive another application request from the Diameter peer, and to generate another application answer in response to the application request. The Diameter node is further operable to determine that an overload condition does not exist, to insert the overload indicator in the application answer that an overload condition does not exist in the Diameter node, and to transmit the application answer to the Diameter peer.

In another embodiment, the Diameter peer is operable to receive the application answer, to parse the application answer to identify the overload indicator which indicates that an overload condition does not exist in the Diameter node, and to send additional application requests toward the Diameter node at a normal rate based on the overload indicator.

Before application requests are exchanged between the Diameter node and the Diameter peer, there should be an exchange of capability information that these two entities support overload handling. In another embodiment, the Diameter node is further operable to receive a capability request from the Diameter peer when initially requesting a transport connection between the Diameter node and the Diameter peer, such as a Diameter Capabilities-Exchange-Request (CER). The Diameter node is operable to generate a capability answer in response to the capability request, such as a Diameter Capabilities-Exchange-Answer (CEA). The Diameter node is operable to parse the capability request to identify a first capability indicator which indicates that the Diameter peer supports overload handling. The Diameter node is further operable to insert a second capability indicator in the capability answer which indicates that the Diameter node also supports overload handling, and to transmit the capability answer to the Diameter peer. The capability request and the capability answer may include a new Attribute Value Pair (AVP) defined for the capability indicators.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIGS. 2-3 are flow charts illustrating a method of exchanging overload handling capabilities via Diameter protocol in an exemplary embodiment.

FIG. 4 is a flow chart illustrating a method of notifying a Diameter peer of overload conditions via Diameter protocol in an exemplary embodiment.

FIG. 5 is a flow chart illustrating a method of limiting requests to a Diameter node in an exemplary embodiment.

FIG. 6 illustrates communication network in another exemplary embodiment.

FIG. 7 is a message diagram illustrating Diameter messaging used to provide overload handling in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

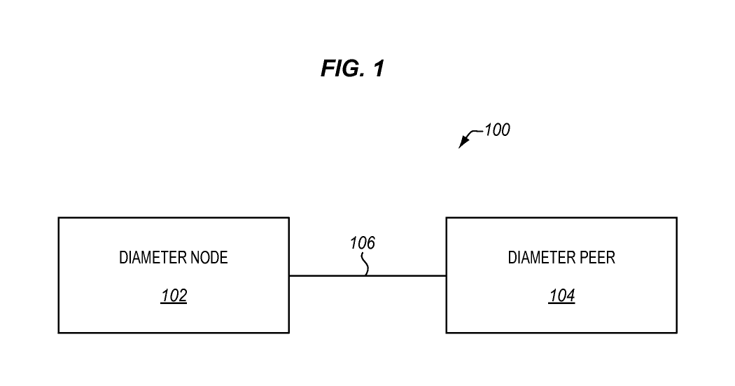

FIG. 1 illustrates a communication network 100 in an exemplary embodiment. Network 100 represents a packet-switched network that uses Diameter (base) protocol, such as an IP Multimedia Subsystem (IMS) network, a Long Term Evolution (LTE) network, etc. In this embodiment, network 100 includes a Diameter node 102 connected to a Diameter peer 104 by a communication path 106. A Diameter node comprises any system or process that implements Diameter protocol, and acts as a client, agent, or server. A Diameter peer comprises any system or process that exchanges Diameter messages with a Diameter node; either directly or through a proxy. Node 102 and peer 104 may represent network elements of a packet-switched network. For example, node 102 may represent a Serving-Call Session Control Function (S-CSCF) of an IMS network, while peer 104 may represent a Home Subscriber Server (HSS) of the IMS network. In another example, node 102 may represent an application server of an IMS network, while peer 104 may represent an Online Charging System (OCS) of the IMS network. Network 100 may include many other Diameter nodes/peers that are not shown for the sake of clarity. Both of node 102 and peer 104 may be referred to as “Diameter nodes” but are given different names to differentiate the two.

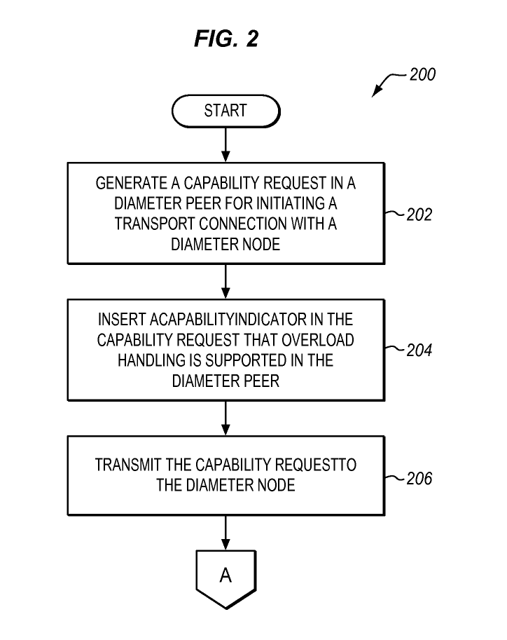

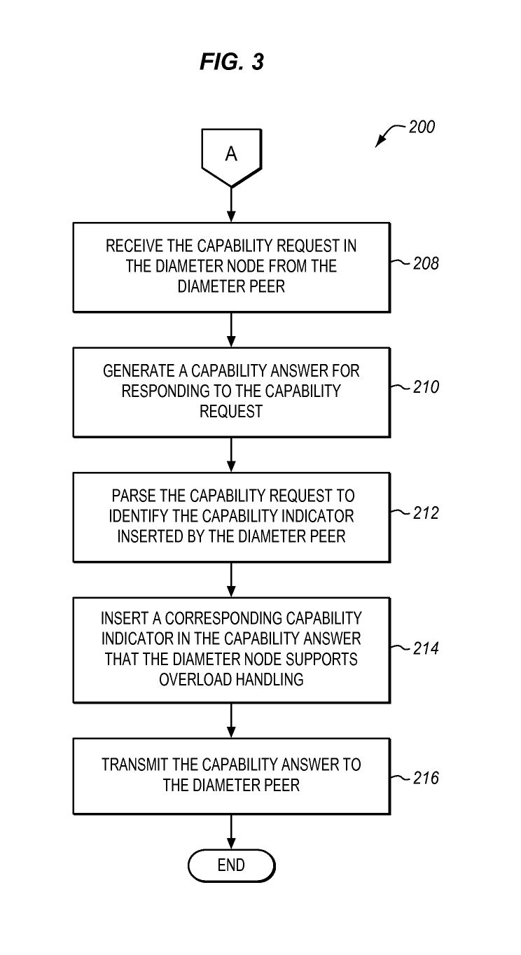

Before node 102 and peer 104 can communicate via Diameter protocol, a transport connection is established between these two elements. The transport connection is established when node 102 and peer 104 exchange data indicating their capabilities for the connection. In the embodiments described herein, the Diameter protocol is enhanced so that node 102 can notify peer 104 that it supports overload handling and vice-versa, which is further described in FIGS. 2-3.

FIGS. 2-3 are flow charts illustrating a method 200 of exchanging overload handling capabilities via Diameter protocol in an exemplary embodiment. The steps of method 200 will be described with reference to network 100 in FIG. 1, but those skilled in the art will appreciate that method 200 may be performed in other networks and systems. The steps of the flow charts described herein are not all inclusive and may include other steps not shown. The steps may also be performed in an alternative order.

Assume for this embodiment that peer 104 initiates a transport connection with node 102. When this occurs, peer 104 generates a capability request in Diameter protocol in step 202 for initiating the transport connection. For example, the capability request may comprise a Diameter Capabilities-Exchange-Request (CER). Another assumption is that peer 104 supports overload handling, so peer 104 inserts an indicator (referred to as a capability indicator) in the capability request that peer 104 supports overload handling in step 204. The indicator may comprise a Boolean value, an integer value, a string, etc. Peer 104 then transmits the capability request to node 102 in step 206. The capability request therefore indicates what peer 104 supports in terms of a transport connection, and also notifies node 102 that peer 104 supports overload handling.

In order to allow for the notification as described above, a new Attribute Value Pair (AVP) may be defined in Diameter protocol for the capability indicator. The new AVP may be added to capability requests, such as in the CER. The new AVP may be named “Overload-Notification-Supported” or something similar. This AVP may have empty content.

In FIG. 3, node 102 receives the capability request from peer 104 in step 208. In response to the capability request, node 102 identifies its own internal capabilities for a transport connection. Node 102 generates a capability answer in Diameter protocol in step 210 for responding to the capability request, and inserts its capabilities for the transport connection in the capability answer. For example, the capability answer may comprise a Diameter Capabilities-Exchange-Answer (CEA). Node 102 also parses the capability request to identify the capability indicator in step 212. If peer 204 supports overload handling, then node 102 determines if it also supports overload handling. If node 102 does support overload handling, then node 102 inserts a corresponding capability indicator in the capability answer in step 214 that node 102 supports overload handling. Node 102 then transmits the capability answer to peer 104 in step 216. The capability answer therefore indicates what node 102 supports in terms of a transport connection, and also notifies peer 104 that node 102 supports overload handling.

The new AVP for the capability indicator may be added to capability answers, such as in the CEA of the Diameter protocol.

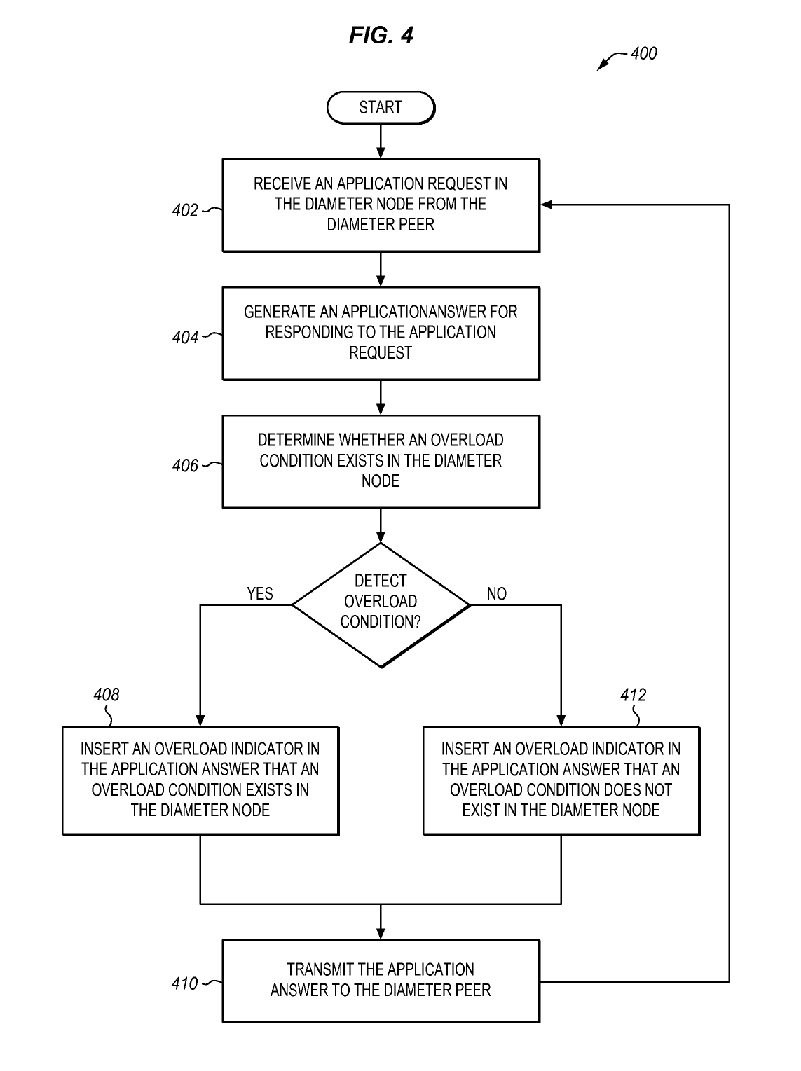

After receiving the capability answer, node 102 and peer 104 may further negotiate parameters, and the transport connection is established. After the transport connection is established, node 102 and peer 104 may exchange further Diameter messages, which may be referred to as application messages. For example, peer 104 may send one or more application requests to node 102, such as a Diameter Device-Watchdog-Request (DWR), a Diameter User-Authentication-Request (UAR), a Diameter Server-Assignment-Request (SAR), etc. In the embodiments described herein, the Diameter protocol is further enhanced so that node 102 can notify peer 104 of overload conditions, which is further described in FIG. 4.

FIG. 4 is a flow chart illustrating a method 400 of notifying a Diameter peer of overload conditions via Diameter protocol in an exemplary embodiment. The steps of method 400 will be described with reference to network 100 in FIG. 1, but those skilled in the art will appreciate that method 400 may be performed in other networks and systems.

In step 402, node 102 receives a Diameter application request from peer 104. One example of the Diameter application request is a Device-Watchdog-Request (DWR). In response to the application request, node 102 generates a Diameter application answer in step 404, such as a Device-Watchdog-Answer (DWA). If peer 104 supports overload handling (based on the prior notification), then node 102 determines whether an overload condition exists in step 406. An overload condition comprises any condition or processing state within a Diameter node that renders the node unable to respond to requests from peers within an expected time frame. For example, if a Diameter node receives a large volume of application requests from multiple peers, such as during a peak time, then the node may become overwhelmed and unable to respond to the requests in a timely manner. When this occurs, the peers may send retry requests to the Diameter node, which exacerbates the overload condition.

In addition to determining whether an overload condition exists, node 102 may also determine a severity level of the overload condition. The severity level may depend on the delay in responding to requests or some other factor.

If an overload condition is detected, then node 102 inserts an overload indicator in the application answer in step 408. The overload indicator comprises any data which indicates whether an overload condition exists in a Diameter node. The overload indicator may comprise a Boolean value, an integer value, a string, etc. For example, the overload indicator may be an integer value in the range of 1-10, 1-100, etc. An integer value greater than zero may indicate that an overload condition exists, and may also indicate the severity level of the overload condition. In this instance, the overload indicator indicates that an overload condition does exist in node 102. Node 102 then transmits the application answer to peer 104 in step 410. Thus, node 102 notifies peer 104 of the overload condition through the Diameter application answer.

In order to allow for the overload notification as described above, a new AVP may be defined in Diameter protocol for the overload indicator. The new AVP may be added to any Diameter answer, such as the Device-Watchdog-Answer (DWA). The new AVP may be named “Overload-Severity” or something similar. Node 102 is able to identify the new AVP in the Diameter answer in order to insert the overload indicator into the proper AVP.

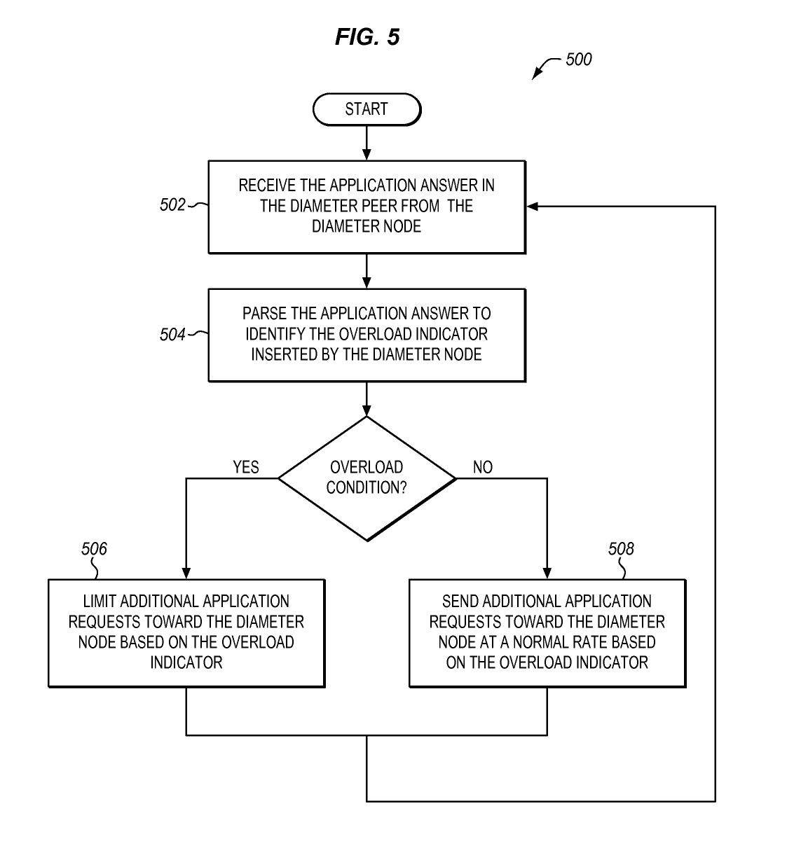

When peer 104 receives an application answer that indicates an overload condition in node 102, peer 104 is able to limit the number of future requests that are sent to node 102 while it is overloaded. FIG. 5 is a flow chart illustrating a method 500 of limiting requests to a Diameter node in an exemplary embodiment. The steps of method 500 will be described with reference to network 100 in FIG. 1, but those skilled in the art will appreciate that method 500 may be performed in other networks and systems.

In step 502, peer 104 receives the application answer from node 102. Peer 104 parses the application answer in step 504 to identify the overload indicator inserted by node 102. If the overload indicator indicates that an overload condition exists in node 102, then peer 104 limits additional application requests toward node 102 based on the overload indicator in step 506. For example, if the overload indicator is an integer value, then peer 104 may limit additional application requests by a percentage based on the integer value. If the integer value is 50 (on a scale of 1 to 100), then peer 104 may limit (or delay) additional application requests by 50%. If the integer value is 80 (on a scale of 1 to 100), then peer 104 may limit (or delay) additional application requests by 80%.

Each time node 102 receives a new application request from peer 104, node 102 may operate as in method 400 to determine whether an overload condition exists and/or the severity level of the overload condition. If the overload condition becomes more or less severe, then node 102 notifies peer through additional application answers. Peer 104 continues to limit additional application requests toward node 102 while the transport connection is established based on the overload indicators provided by node 102.

Much like node 102 is able to notify peer 104 when an overload condition exists, node 102 is able to notify peer 104 when no overload condition exists or when a prior overload condition has recovered, as is further shown in FIG. 4. When node 102 receives a Diameter application request from peer 104 (see step 402), node 102 generates a Diameter application answer (in step 404) and determines whether an overload condition exists (in step 406). If node 102 does not detect an overload condition or identifies a prior overload condition has recovered, then node 102 inserts an overload indicator in the application answer in step 412 which indicates that an overload condition does not exist or that an overload condition has recovered. The overload indicator may be an integer value that equals zero, such as on a scale of 1-10, 1-100, etc. An integer value of zero indicates that no overload condition exists, or that the severity level of an overload condition is zero. Node 102 then transmits the application answer to peer 104 in step 410. Therefore, node 102 is able to notify peer 104 that no overload condition exists through the Diameter application answer.

When peer 104 receives the application answer from node 102 (see step 502 of FIG. 5), peer 104 parses the application answer to identify the overload indicator inserted by node 102 (see step 504). In this instance, the overload indicator indicates that no overload condition exists in node 102. Therefore, peer 104 sends additional application requests toward node 102 at a normal rate in step 508. If peer 104 had previously limited application requests toward node 102 because it was notified of an overload condition in node 102, then peer 104 can return to normal operation and send additional application requests toward node 102 in a normal fashion.

### EXAMPLE

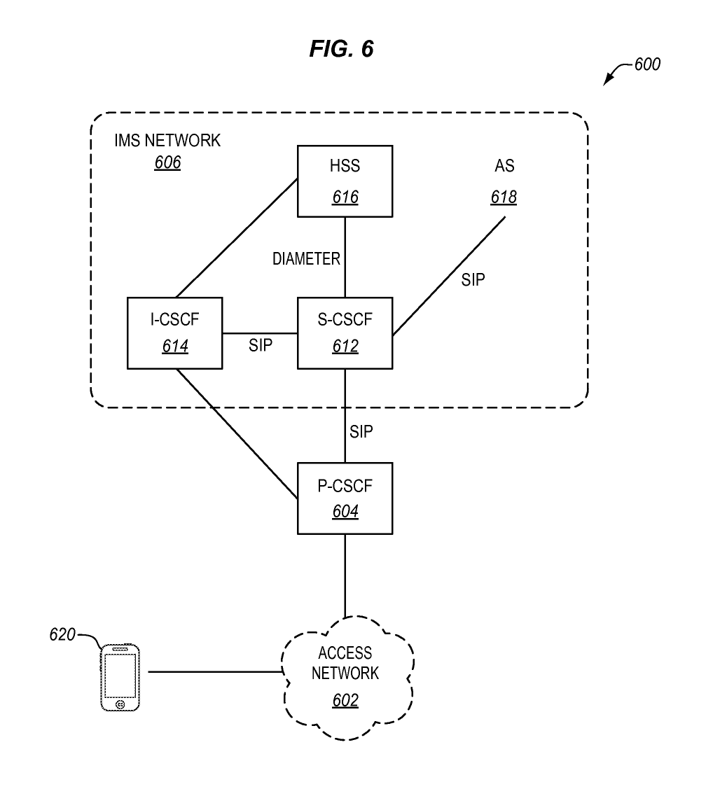

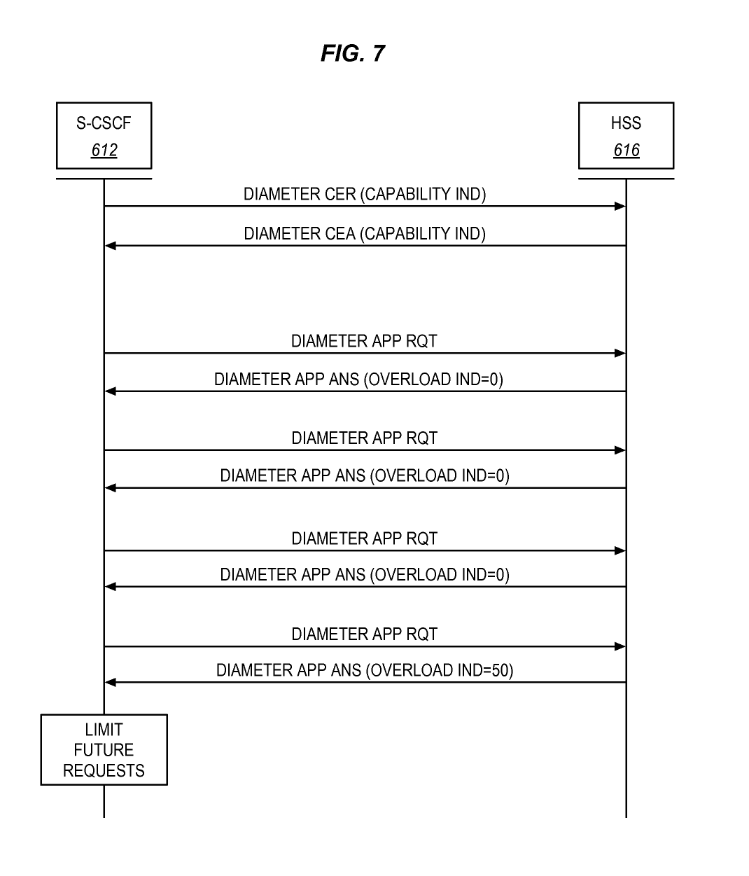

FIGS. 6-7 illustrate an example of operating an IMS network to provide overload handling through Diameter protocol. FIG. 6 illustrates communication network 600 in another exemplary embodiment. Communication network 600 includes an access network 602, a Proxy-Call Session Control Function (P-CSCF) 604, and an IMS network 606. IMS network 606 includes a Serving-Call Session Control Function (S-CSCF) 612, an Interrogate-CSCF (I-CSCF) 614, a Home Subscriber Server (HSS) 616, and an application server (AS) 618. A mobile device 620 connects to IMS network 606 through access network 602.

FIG. 7 is a message diagram illustrating Diameter messaging used to provide overload handling in an exemplary embodiment. In this example, assume that S-CSCF 612 is able to communicate with HSS 616 using Diameter protocol. For these two network elements to begin communication, S-CSCF 612 requests a transport connection with HSS 612. Therefore, S-CSCF 612 generates a Diameter Capabilities-Exchange-Request (CER) to request the transport connection, and inserts its capabilities for a connection in the CER. One assumption is that S-CSCF 612 supports overload handling, so S-CSCF 612 also inserts a capability indicator in the CER indicating that S-CSCF 612 supports overload handling. S-CSCF 612 inserts the capability indicator (CAPABILITY IND) in a new AVP defined in the CER for the capability indicator. S-CSCF 612 then transmits the CER to HSS 616. The CER therefore notifies HSS 616 that S-CSCF 612 supports overload handling.

In response to receiving the CER, HSS 616 identifies its own internal capabilities for the transport connection. HSS 616 generates a Diameter Capabilities-Exchange-Answer (CEA) for responding to the CER, and inserts its capabilities for the transport connection in the CEA. Because the CER includes a capability indicator which shows that S-CSCF 612 supports overload handling, HSS 616 determines whether it also supports overload handling. If it does, then HSS 616 inserts a corresponding capability indicator in the CEA indicating that HSS 616 supports overload handling. HSS 616 inserts the capability indicator in a new AVP defined in the CEA for the capability indicator. HSS 616 then transmits the CEA to S-CSCF 612. The CEA therefore notifies S-CSCF 612 that HSS 616 supports overload handling. At this point, S-CSCF 612 and HSS 616 may further negotiate parameters for the transport connection, and the connection is established.

With the transport connection established, S-CSCF 612 may send multiple Diameter application requests toward HSS 616, such as a Diameter User-Authentication-Request (UAR), a Diameter Server-Assignment-Request (SAR), a Diameter Device-Watchdog-Request (DWR), etc. When the application requests are received, HSS 616 generates the appropriate Diameter application answer, such as a Diameter User-Authentication-Answer (UAA), a Diameter Server-Assignment-Answer (SAA), a Device-Watchdog-Answer (DWA), etc. Because both HSS 616 and S-CSCF 612 support overload handling based on the prior notifications, then HSS 616 determines whether an overload condition exists and a severity level of the overload condition.

If an overload condition is not detected (as with the first three Diameter application requests), then HSS 616 inserts an overload indicator (OVERLOAD IND) in the application answer that no overload condition exists. More particularly, HSS 616 inserts the overload indicator in a new AVP defined for Diameter answers. In this example, the overload indicator comprises an integer value in the range of 1-100. An integer value of zero indicates that an overload condition does not exist. HSS 616 then sends the application answer to S-CSCF 612.

If an overload condition is detected (as with the fourth Diameter application request), then HSS 616 inserts an overload indicator in the application answer that an overload condition does exist. An integer value greater than zero (e.g., 50 in FIG. 7) indicates that an overload condition exists, and also indicates the severity level of the overload condition. Because an overload condition was detected, the overload indicator is a value between 1-100 depending on the severity of the overload condition. HSS 616 then transmits the application answer to S-CSCF 612.

When S-CSCF 612 receives an application answer that indicates an overload condition in HSS 616, S-CSCF 612 is able to limit the number of future requests that are sent to HSS 616 while it is overloaded. For example, if the overload indicator is an integer value of 50 (on a scale of 1 to 100), then S-CSCF 612 may limit (or delay) additional application requests by 50%. By limiting future requests toward HSS 616, the overload condition may be resolved more quickly or easily.

The above example illustrates that overload handling can be implemented effectively through Diameter protocol. The addition of new AVPs in the Diameter (base) protocol allows Diameter nodes, such as S-CSCF 612 and HSS 616, to notify one another of overload handling capabilities and overload conditions so that networks can operate more efficiently.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a Diameter node operable to receive a Diameter application request from a Diameter peer, and to generate a Diameter application answer in response to the application request;
the Diameter node is further operable to detect an overload condition, to insert an overload indicator in the application answer that an overload condition exists in the Diameter node, and to transmit the application answer to the Diameter peer.

2. The system of claim 1 wherein:
the Diameter peer is operable to receive the application answer, to parse the application answer to identify the overload indicator which indicates that an overload condition exists in the Diameter node, and to limit additional application requests toward the Diameter node based on the overload indicator.

3. The system of claim 1 wherein:
the application answer includes a new Diameter Attribute Value Pair (AVP) defined for the overload indicator.

4. The system of claim 1 wherein:
the Diameter node is further operable to receive another application request from the Diameter peer, and to generate another application answer in response to the other application request;
the Diameter node is further operable to determine that an overload condition does not exist, to insert the overload indicator in the other application answer that an overload condition does not exist in the Diameter node, and to transmit the other application answer to the Diameter peer.

5. The system of claim 4 wherein:
the Diameter peer is operable to receive the other application answer, to parse the other application answer to identify the overload indicator which indicates that an overload condition does not exist in the Diameter node, and to send additional application requests toward the Diameter node at a normal rate based on the overload indicator.

6. The system of claim 1 wherein:
the Diameter node is further operable to receive a capability request from the Diameter peer when initially requesting a transport connection between the Diameter node and the Diameter peer, to generate a capability answer in response to the capability request, and to parse the capability request to identify a first capability indicator which indicates that the Diameter peer supports overload handling;
the Diameter node is further operable to insert a second capability indicator in the capability answer which indicates that the Diameter node also supports overload handling, and to transmit the capability answer to the Diameter peer.

7. The system of claim 6 wherein:
the capability request and the capability answer include a new Diameter Attribute Value Pair (AVP) defined for the capability indicators.

8. The system of claim 7 wherein:
the capability request comprises a Diameter Capabilities-Exchange-Request (CER); and
the capability answer comprises a Diameter Capabilities-Exchange-Answer (CEA).

9. A method comprising:
receiving a Diameter application request in a Diameter node from a Diameter peer;
generating a Diameter application answer in response to the application request;
detecting an overload condition;
inserting an overload indicator in the application answer that an overload condition exists; and
transmitting the application answer from the Diameter node to the Diameter peer.

10. The method of claim 9 further comprising:
receiving the application answer in the Diameter peer;
parsing the application answer to identify the overload indicator which indicates that an overload condition exists; and
limiting additional application requests toward the Diameter node based on the overload indicator.

11. The method of claim 9 wherein:
the application answer includes a new Diameter Attribute Value Pair (AVP) defined for the overload indicator.

12. The method of claim 9 further comprising:
receiving another application request in the Diameter node from the Diameter peer;
generating another application answer in response to the other application request;
determining that an overload condition does not exist;
inserting the overload indicator in the other application answer that an overload condition does not exist; and
transmitting the other application answer from the Diameter node to the Diameter peer.

13. The method of claim 12 further comprising:
receiving the other application answer in the Diameter peer;
parsing the other application answer to identify the overload indicator which indicates that an overload condition does not exist; and
sending additional application requests toward the Diameter node at a normal rate based on the overload indicator.

14. The method of claim 9 further comprises:
receiving a capability request from the Diameter peer when initially requesting a transport connection between the Diameter node and the Diameter peer;
generating a capability answer in response to the capability request;
parsing the capability request to identify a first capability indicator which indicates that the Diameter peer supports overload handling;
inserting a second capability indicator in the capability answer which indicates that the Diameter node also supports overload handling; and
transmitting the capability answer from the Diameter node to the Diameter peer.

15. The method of claim 14 wherein:
the capability request and the capability answer include a new Diameter Attribute Value Pair (AVP) defined for the capability indicators.

16. The method of claim 15 wherein:
the capability request comprises a Diameter Capabilities-Exchange-Request (CER); and
the capability answer comprises a Diameter Capabilities-Exchange-Answer (CEA).

17. A method comprising:
receiving a Diameter request in a first node from a second node;
generating a Diameter answer for the Diameter request;
identifying a new Attribute Value Pair (AVP) in the Diameter answer defined for an overload indicator that indicates an overload condition in the first node;
inserting a value in the new AVP that indicates the overload condition; and
transmitting the Diameter answer from the first node to the second node.

18. The method of claim 17 wherein:
the overload indicator inserted in the new AVP further indicates a severity level of the overload condition.

19. The method of claim 18 wherein:
an integer value of 0 indicates a normal operating condition; and
an integer value greater than 0 indicates the severity level of the overload condition.

20. The method of claim 17 further comprising:
receiving another Diameter request in the first node from the second node when initially requesting a transport connection between the nodes;
generating another Diameter answer for the other Diameter request;
identifying a new Attribute Value Pair (AVP) in the other Diameter request defined for a capability indicator which indicates that the second node supports overload handling;
inserting a corresponding capability indicator in the new AVP of the other Diameter answer which indicates that the second node also supports overload handling; and
transmitting the other Diameter answer from the first node to the second node.
